(19) United States
(12) Patent Application Publication
(10) Pub. No.: US 2016/0307383 A1
(43) Pub. Date: Oct. 20, 2016

(54) ELECTRONIC APPARATUSES AND METHODS FOR ACCESS CONTROL AND FOR DATA INTEGRITY VERIFICATION

(71) Applicant: SECUREALL CORPORATION, Mountain View, CA (US)

(72) Inventors: Arun Kumar Sharma, Cupertino, CA (US); Michael Wurm, Redwood City, CA (US); Prajakta Setty, Santa Clara, CA (US); Oscar Trampe, Dublin, CA (US); Ranadheer Solleti, Santa Clara, CA (US)

(21) Appl. No.: 15/006,993

(22) Filed: Jan. 26, 2016

Related U.S. Application Data
(63) Continuation of application No. 13/841,079, filed on Mar. 15, 2013, now abandoned.

(51) Int. Cl. G07C 9/00

(52) U.S. Cl. CPC G07C 9/00174

(57) ABSTRACT

Improved access control systems (100) are provided which control access to resources. Among other things, improved techniques are provided for checking for access control data integrity. These techniques are not limited to access control data or systems.

### CROSS REFERENCE TO RELATED APPLICATIONS

The present application is a continuation of U.S. patent application Ser. No. 13/841,079, filed Mar. 15, 2013, incorporated herein by reference, which claims priority of U.S. provisional application No. 61/611,575 filed Mar. 16, 2012, incorporated herein by reference.

### BACKGROUND OF THE INVENTION

The present invention relates to access control systems (ACSs) such as can be used to control access to various resources, e.g. rooms or other areas protected by electronic door locks.

In a typical ACS, an electronic door lock (EDL) is opened by an electronic key, e.g. a card key. The key can be carried by a human user or attached to a vehicle for example. A remote computer configures the EDLs to allow entry for some users while keeping out others. It is desirable to provide an improved ACS which facilitates operation of the remote computer and has improved EDLs.

### SUMMARY

This section summarizes some features of the invention. Other features may be described in the subsequent sections. The invention is defined by the appended claims, which are incorporated into this section by reference.

Some embodiments of the present invention provide improved access control systems and methods. Some embodiments provide data integrity verification methods for verifying the integrity of access control data stored on the EDLs. Some embodiments of the data integrity verification methods are applicable to data unrelated to access control systems.

### BRIEF DESCRIPTION OF THE DRAWINGS

FIG. 1A is a block diagram of an access control system according to some embodiments of the present invention.

FIGS. 1B, 2A-1, 2A-2, 2A-3 illustrate data relationships in access control systems according to some embodiments of the present invention.

FIG. 2B shows a computer screen image displayed by access control systems according to some embodiments of the present invention to define zones as related to domains and access control lists (ACLs) as described below.

FIG. 2C shows a computer screen image displayed by access control systems according to some embodiments of the present invention to manage domains as related to access control lists (ACLs) as described below.

FIG. 2D shows a computer screen image displayed by access control systems according to some embodiments of the present invention to manage users as related to zones, domains and access control lists (ACLs) as described below.

FIG. 2E a computer screen image displayed by access control systems according to some embodiments of the present invention to manage access groups as related to zones, domains and access control lists (ACLs) as described below.

FIG. 3A illustrates users and access groups in access control systems according to some embodiments of the present invention.

FIG. 3B shows a computer screen image displayed by access control systems to enroll (add) a user to an access group according to some embodiments of the present invention.

FIG. 4A illustrates roles and users' GUI privileges in access control systems according to some embodiments of the present invention.

FIG. 4B shows a computer screen image displayed by access control systems to manage roles in connection with tasks according to some embodiments of the present invention.

FIG. 4C shows a computer screen image displayed by access control systems to assign roles to users according to some embodiments of the present invention.

FIG. 5 illustrates domains and zones in access control systems according to some embodiments of the present invention.

FIG. 6 shows a computer screen image displayed by access control systems to manage a facility (organization) model according to some embodiments of the present invention.

FIG. 7 shows a computer screen image displayed by an access control system to provide system status and alarm and task information according to some embodiments of the present invention.

FIG. 8 shows a computer screen image displayed by an access control system to provide system status and alarm and task information, including a lock down screen, according to some embodiments of the present invention.

FIG. 9 is a block diagram of an electronic door lock according to some embodiments of the present invention.

FIG. 10 shows memory with data in electronic door locks according to some embodiments of the present invention.

FIG. 11 illustrates data integrity verification according to some embodiments of the present invention.

### DESCRIPTION OF SOME EMBODIMENTS

The embodiments described in this section illustrate but do not limit the invention. The invention is defined by the appended claims.

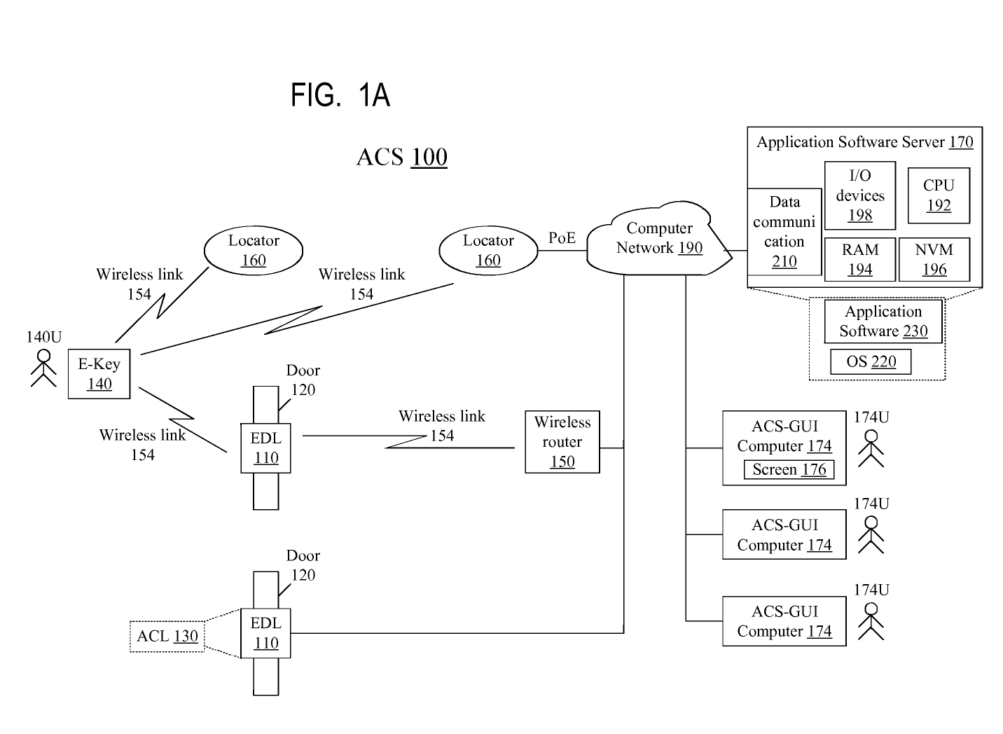

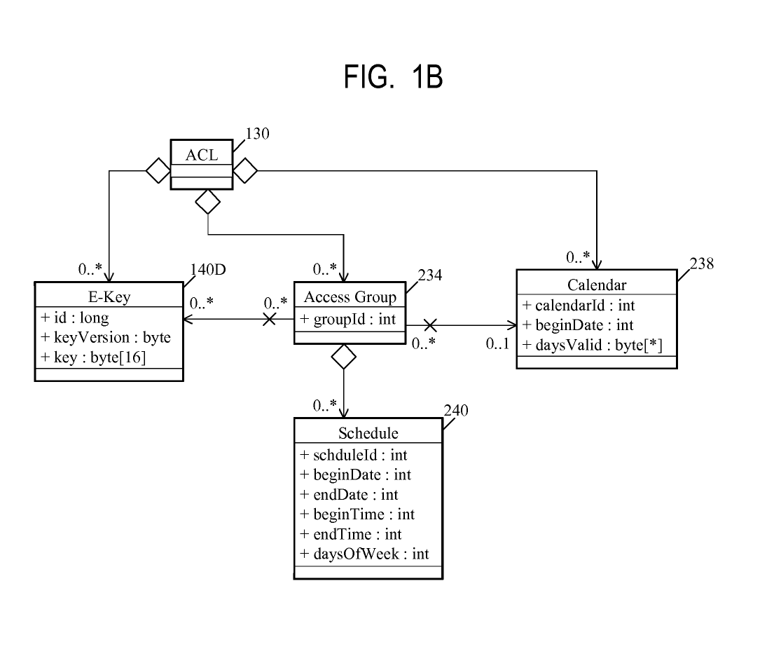

FIG. 1A shows an exemplary access control system (ACS) 100 which employs some features of prior art but also incorporates some embodiments of the present invention. The following abbreviations are used below.

### GLOSSARY

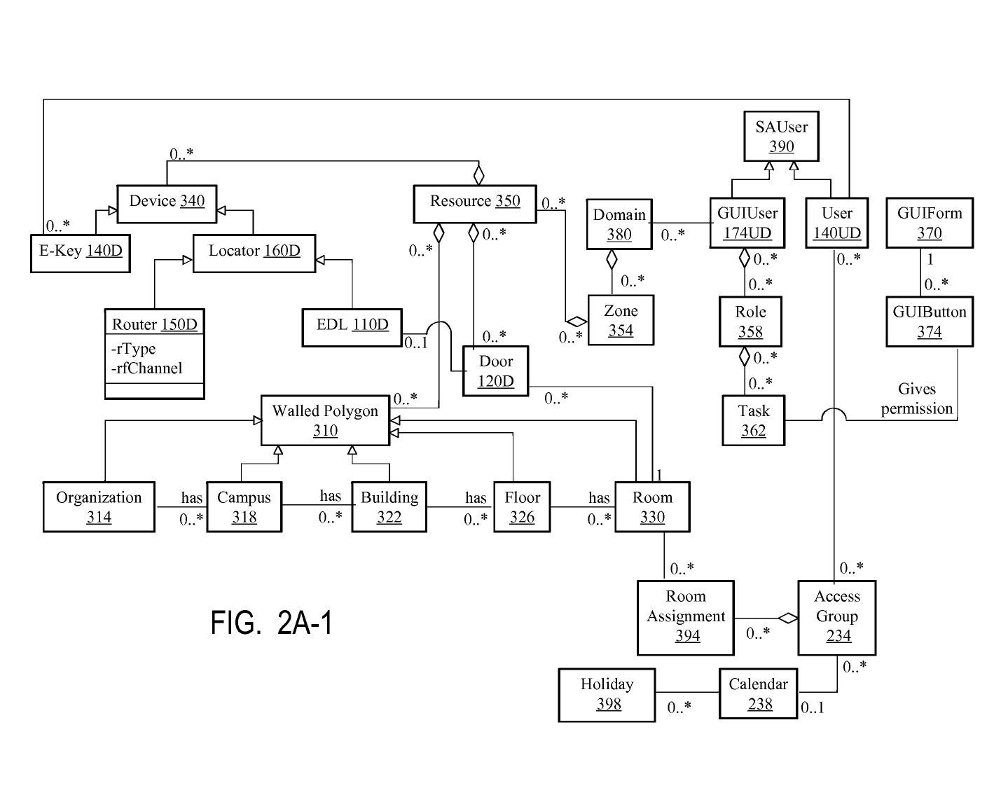

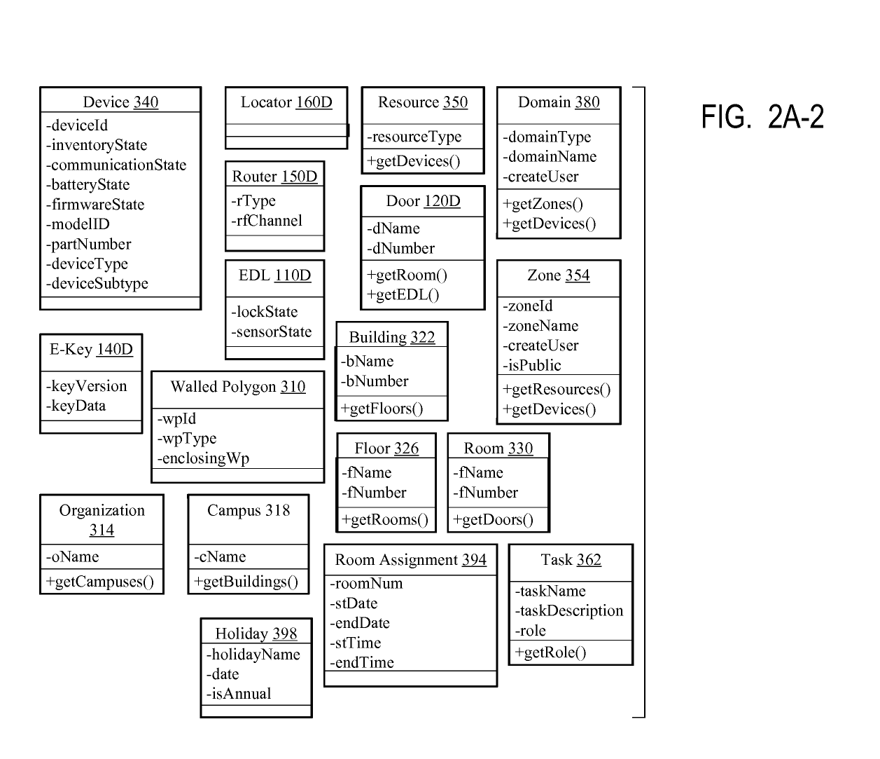

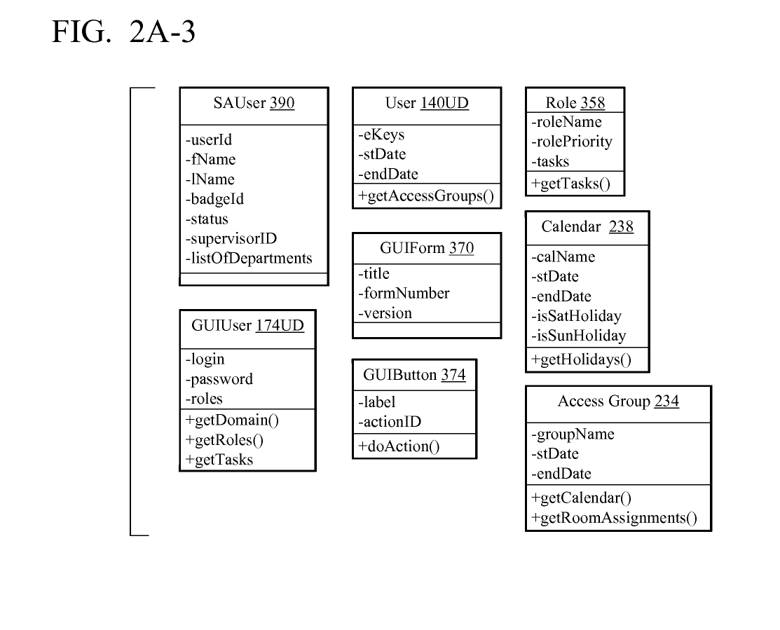

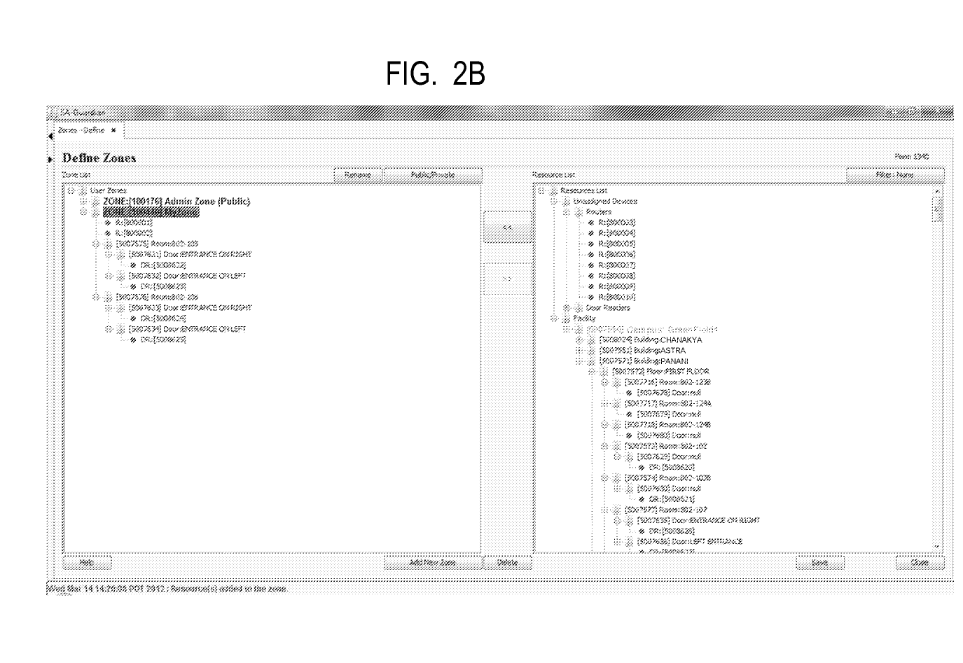

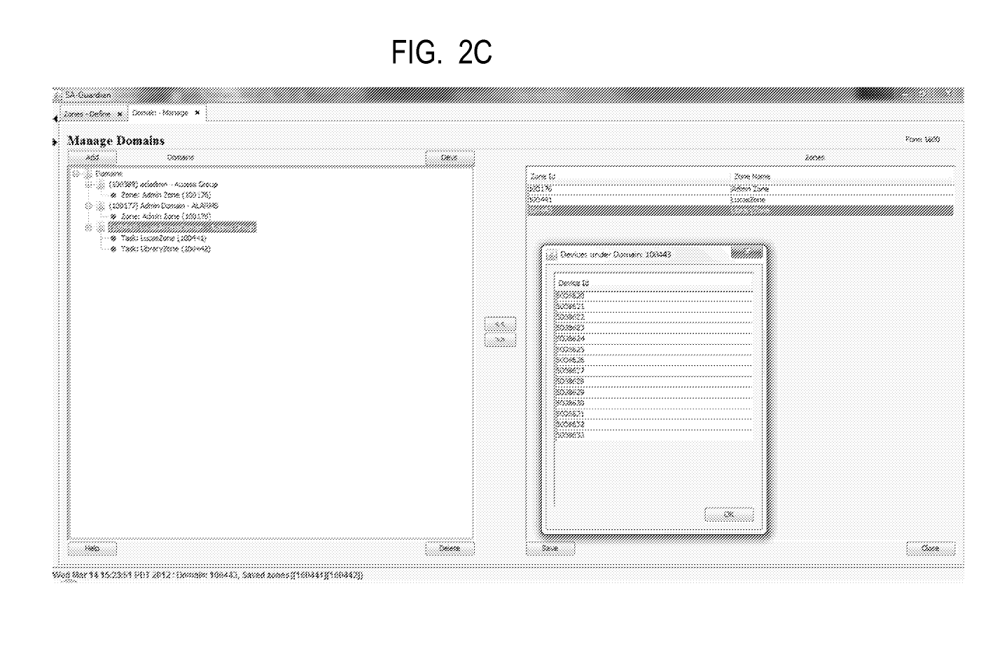

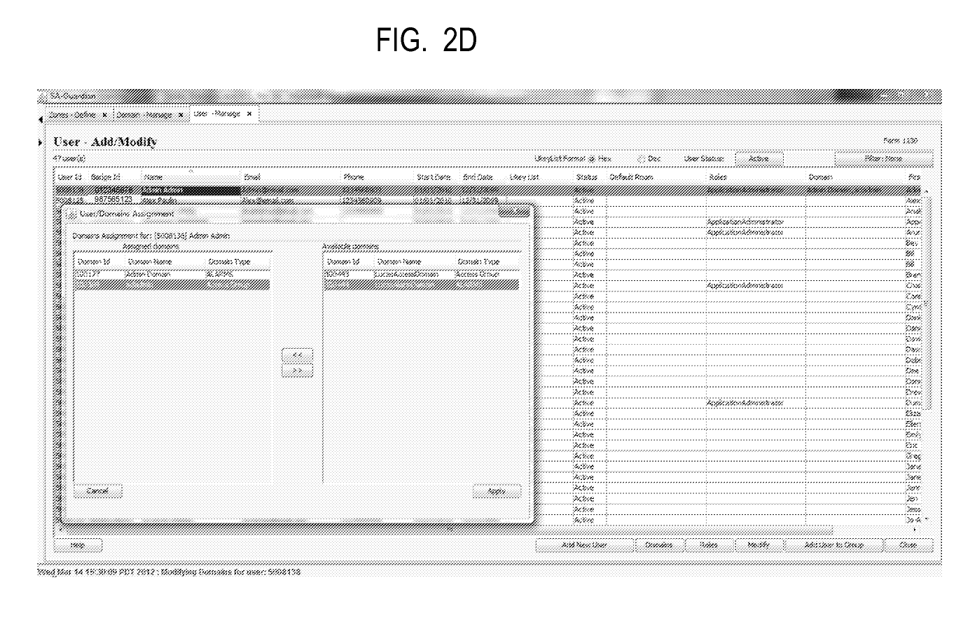

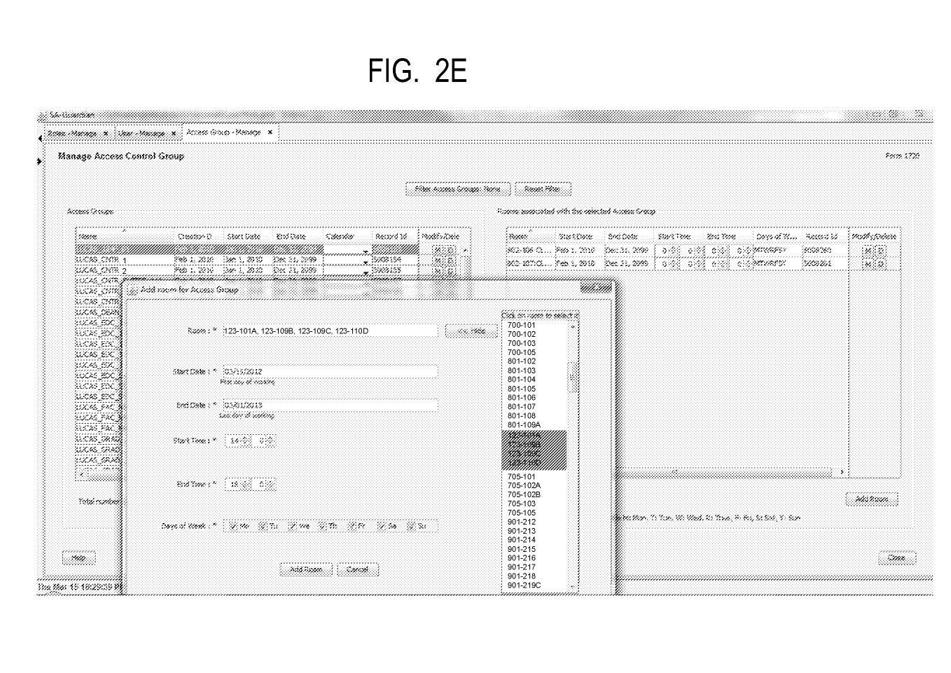

1. RSSI: Receiver Signal Strength Indicator.
2. EDL: Electronic door lock. (FIG. 1A shows two exemplary EDLs 110 on doors 120.)
3. Electronic door reader: Same as EDL.
4. Door Reader: Same as EDL.
5. ACL: Access Control List. (An example is shown at 130 in FIG. 1A.) ACL includes information stored in an EDL's local database and specifying all electronic keys (such as 140, also called E-Keys or U-Keys, e.g. card keys, magnetic stripe cards, passive or active RFID devices, etc., shown at 140) that have access to the EDL. ACL 130 also specifies, for each E-key 140, the date and time-of-day period when access is allowed.
6. E-key (an example is shown at 140): Is carried by a human user 140U. The E-key communicates with the EDL 130 as well as Routers (such as 150) and Locators (such as 160).
7. ACS: Access Control System (100).
8. AS: Application Software (such as 230)
9. AS-Server: Application Software Server (such as 170) which runs the Application Software.
10. ACS-GUI User Computer (such as 174), accessible to a GUI user (a human, such as 174U). Each computer 174 provides a Graphical User Interface (174) for GUI users 174U.
11. GUI Screen (176) is a screen of a computer 174.
12. ACL Schedule: Same as ‘Room Assignment’
13. PLC: Programmable Logic Controller (not shown)
1. Access Control Systems (ACS) 100 have existed for a few decades, that allow centralized administration of people's access to rooms whose door are equipped with EDLs 110. Access can be provided or denied to users 140U who carry E-Keys 140.
2. Most ACS 100 employ wired connection between AS-Server 170 with EDL 110, while some employ an elaborate door controller (similar to PLC) located close to few nearby doors. The door controller has local intelligence to control one or more doors and communicate with AS-Server 170.
3. Electronic Door Locks (EDL) 110 typically use electronic keys (E-Key) 140 in the form of card keys or key-fobs (e.g. Magnetic stripe card, Passive RFID, Active RFID, ID Chip (including SMART CHIP) with galvanic contacts, etc. or other types).
4. The exemplary ACS 100 of FIG. 1A is constructed according to some embodiments of the present invention, and comprises:
   a. Application Software Server (AS Server) 170: The server that runs the Application Software (AS) 230. AS has repository of access control information for all doors in the facility. Only authorized users 174U can access the information or modify it.
   b. Wireless Router 150: A device that is connected, via a computer network 190, to the AS server 170. Router 150 uses via wireless link(s) 154 to provide connectivity between AS Server 170 and wireless devices like:
      i. EDLs 110
      ii. E-keys 140
      iii. Other routers
   c. AS Server 170 is a computer system comprising:
      i. CPU 192
      ii. RAM (random access memory) 194
      iii. Non-Volatile Memory 196
      iv. Input Output devices 198 for use by humans
      v. Data communication interface 210 for connection to network 190
      vi. Operating System 220
      vii. Application Software 230.
   d. AS Server 170 could be hosted in various ways including but not limited to the following:
      i. Within customer site
      ii. Offsite hosted environment
      iii. Cloud server
   e. The computer network 190 provides data communication connectivity between AS Server 170, User Computers 174, Routers 150 and Locators 160. The network can be implemented in many ways using various types of network hardware and protocols, including but not limited to the following:
      i. Local Area Network
      ii. Wide Area Network
      iii. TCP/IP
      iv. UDP
      v. Tunneling protocol
   f. ACS-GUI computers 174 use their screens 176 to provide GUI interface to authorized users 174U. Examples of authorized users 174U include security personnel (such as responsible for campus safety), a facilities access administrator, a residence hall administrator (on a university campus for example). A computer 174 could be hosted in various ways including but not limited to the following:
      i. Desktop computer
      ii. Laptop
      iii. PDA (Personal Digital Assistant)
      iv. Mobile computing platform including, for example, smart-phone or pad devices
      v. Web-browser or a native GUI software platform
   g. An EDL 110 communicates with an E-Key 140 to determine whether to provide access. EDL 110 also communicates with AS Server 170. In particular, EDL 110:
      1. Receives command messages from AS server 170 and responds with response messages
      2. Sends to AS server 170 asynchronous event reports and alarm reports
   h. A locator 160 communicates with an e-key 140 and gets RSSI information, and reports it to the application software server 170. The locator thus performs largely the same functions as the EDL, so it can be viewed as a variant of an EDL, or an EDL can be viewed as an enhanced locator (for example, in the class diagram of FIG. 2A-1 discussed below, an EDL is modeled as a subclass of a locator; the invention is not limited to any modeling). Of note:
      i. Unlike an EDL, the locator does not have any physical lock mechanism to control or operate.
      ii. The locator is packaged differently from an EDL.
      iii. The locator may have multiple antennas like an EDL but may have a single antenna.
      iv. The locator communicates with an E-key 140 in the locator's neighborhood, gets communication RSSI information and reports it to the application software server 170 via a router device.
      v. The locator could be powered by a battery or by AC main power.
   i. E-key 140 is carried by a user 140U. It communicates with EDLs 110. Optionally it can communicate with Routers 150 and Locators 160.
5. Prior art ACSs for large facilities (and large customers) have many problems that arise from mismatch of functionality provided by the application software versus the way customers are organized and their specific business processes. The following is a non-exhaustive list of problems/issues that customers with large facilities have with prior art ACSs.
6. Configuration (using an AS server to configure the ACS):
   a. Controlling access to rooms: Buildings (or floors in a building) can be owned by different departments, and each department wants to have exclusive control over granting access to rooms that belong to the department.
      i. A conventional ACS may give, to privileged users 174U, access to ACS-GUI computers 174 to grant/modify access to rooms belonging to the department, but the ACS does not prevent those privileged users from granting access to rooms belonging to other departments (or other owners). It requires personal discipline, personal integrity and trust to make the ACS work, and the customers are forced to live with its limitations.
      ii. Some customers also want, for each department, to prevent privileged ACS-GUI user peers 174U from other departments from being able to determine which people 140U have access to rooms in their department. Thus, each department wants to:
         1. manage its room resources as the department wishes so as to meet its needs,
         2. prevent other (peer) departments from
         a. meddling in its affairs;
         b. or gaining information on how it operates or manages itself.
   b. Alarm handling: As noted above, buildings (or floors in a building) can be owned by different departments, and each department wants to have exclusive control over handling alarms and events arising from resources and rooms that belong to the department.
      i. A conventional ACS may give, to privileged users 174U, access to ACS-GUI computers 174 to view and handle alarms that arise from all resources and rooms in the ACS. The ACS does not prevent those privileged users from handling alarms for rooms belonging to other departments (or other owners). It requires personal discipline, personal integrity and trust to make the ACS work, and the customers are forced to live with its limitations.
   c. Ease of configuration: Most ACSs provide rudimentary functionality of Access Groups and Calendars.
      i. An Access Group is a collection of schedules for a set of rooms. An exemplary collection of schedules is: Monday through Friday access to Lecture rooms K101, K104, R109, J203 from 0900 Hrs to 1700 Hrs.
      ii. Users 140U (carriers of E-keys 140) can be assigned membership in one or more Access Groups to automatically acquire access defined by the corresponding schedules. This is easier than repetitively configure each user for each schedule.
      iii. A calendar is a list of Holidays (or “Blackout Days”) when access shall not be granted to a user 140U even if the user is a member of an Access Group that has scheduled access for that day of the week and that time of day.
      iv. The ACS may also provide, for an individual user 140U, a start-date and end-date, that is more limited than the schedules provided by the Access Group of which the user may be a member.

Improved configuration capabilities are desirable.

### EDL Speed:

7. An electronic door reader 110 may be required to make access decisions independently and in real time. A further possible requirement is that access control information (ACL 130) is stored in a way that is memory efficient, both to reduce the amount of memory required for storage, and to reduce the bandwidth required to transmit the ACL by server 170.
8. Doors 120 that are used by many people can have thousands of user entries in their ACL. A possibility to optimize storage space is to define groups of users 140U who share the same access rules and to define these rules only once for each group. These groups can be implemented using the Access Group paradigm described above.
9. An ACL 130 in a door reader 110 can be very complex; however it is critical to the security of the system that the ACL is correct. In particular, the access rules for a user 140U can be very complex and there can be no guaranteed upper bound for the time it takes for an EDL 110 to evaluate access rules for a user 140U that requests access. In the worst case a user 140U can be part of all groups and evaluating access for this user would require reading all the groups' records.
10. Another potential performance issue is in finding the record of a user 140U. The EDL may use a serial flash memory for bulk storage. This type of memory has relatively slow read speeds and long delays when reads are not sequential. Thus sequential searching can be slow. As to writing operations, flash memories can typically sustain only a limited number of write cycles per memory location, and writing requires erasing entire pages of memory at a time. These limitations make it very hard to implement more sophisticated data structures in flash memory that could be used to speed up search algorithms.

### ACL Verification:

11. It is desirable to be able to verify that the ACL 130 as it is stored in a door reader in fact represents the access rules configured in at AS server 170. A simple approach would be for server 170 to obtain the ACL 130 from the reader 110 and compare this ACL to the ACL stored on server 170. This can turn into a bandwidth problem when there are multiple readers with ACLs that can be several megabytes each. In addition, for an energy-constrained device (e.g. battery-powered device), transmission or reception of large data amounts carries penalty of energy consumption.

Some embodiments provide solutions to such problems. More particularly:

Configuration:

Some embodiments of the present invention provide new configuration capabilities. In particular, in some embodiments, a user 174U can be given authority to configure, or view the configuration of, a set of EDLs 110 or other devices (the set is sometimes called a “domain” herein), but not the devices outside of the set. A user 174U or 140U can be allowed to configure or own alarm-handling rights for a set of devices but not for other devices.

In some embodiments, an Access Group can be configured so as to be valid for only a limited number of days. Some embodiments associate an Access Group with Start and End dates that are Access Group specific.

In some embodiments, each Access Group is associated with its own specific calendar, and different Access Groups can be associated with different calendars. The structure of an exemplary ACL 130 according to some embodiments of the present invention is shown in FIG. 1B. In this example, ACL 130 includes an aggregation of any number (zero or more) of E-Key structures 140D, and also includes an aggregation of any number of Group structures 234, and an aggregation of any number of Calendar structures 238. Each E-key structure 140D corresponds to an E-Key 140.

Each group 234 corresponds to an Access Group, and contains the Access Group's ID and an aggregation of any number of schedule structures 240.

A group structure 234 can be associated with any E-key structures 140D which are members of the Access Group. A group structure 234 can be associated with zero or one calendars 238 applicable to all the schedules in the group. A schedule structure 240 can be associated with zero or one calendar structures 238.

An access group defines days and times of day when the group's members 140U have access. A user 140U can be in multiple groups. The user has access when at least one of the groups containing the user has access.

For example, an Access Group for sports classes may have a calendar schedule depending on a team's tournament registration; while an Access Group for academic classes may have a different calendar, which in turn may be different from an Access Group for religious classes. In contrast, in a conventional ACS, the same calendar is effective for all Access Groups.

Other configuration capabilities are also provided.

EDL Speed

In some embodiments, the EDL speed is enhanced by caching access control data for a period including the current time. The cache is refreshed as the current time advances, so the cache always has data relevant to the current time.

The inventors have realized that the EDL speed improvements can be particularly desirable for hand-free operation. In hand-free operation, the E-Key 140 may communicate with EDL 110 when the E-Key is carried, for example, in the user's bag or pocket; the E-Key does not have to be in close proximity with the EDL. When the E-Key and the EDL are discovering each other and the EDL checks its ACL to determine whether the user is allowed access, the E-Key may keep its radio on, waiting for the EDL messages. The radio consumes much energy, and this is undesirable since the E-Key is not connected to a stationary power supply. It is therefore highly desirable for the EDL to make the access decisions in a short, predictable interval of time.

Data Integrity

Improved techniques for checking for data integrity between server 170 and EDLs 110 are also provided. In some embodiments, checksums are used to check for data integrity without transmitting the actual data. A checksum can be computed on a plurality of records. If checksums do not match of the plurality, then checksums are computed on individual records or subsets of records within the plurality to identify the individual record or subset which lacks integrity.

Personalized Access Modes

In some embodiments, users 140U are provided with personalized access modes depending on the users' needs. E.g. wheelchair users may need more time for entry, so the EDL can unlock the door at a greater distance from the user.

There is a number of other problems solved by some embodiments of the present invention as discussed below. The invention is not limited to embodiments solving such problems.

Below, the term “computer network” may refer to the computer network 190 with or without the wireless links 154.

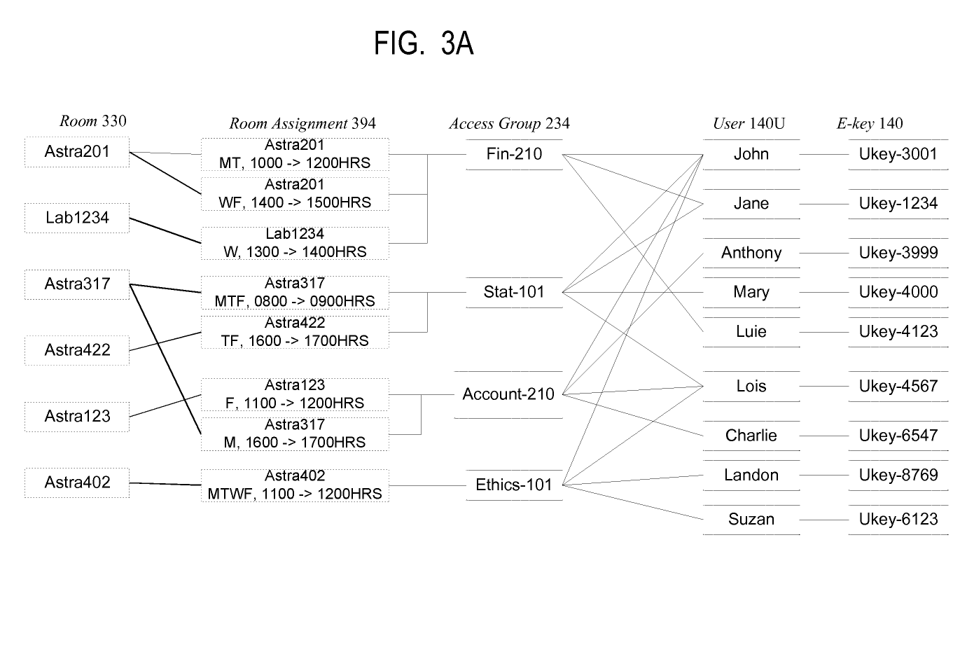

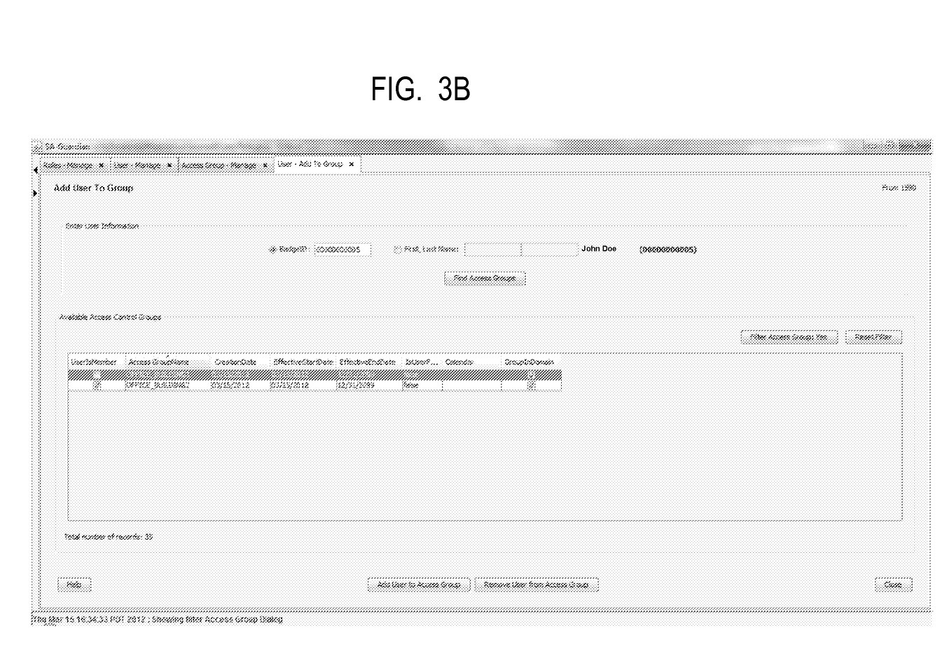

FIG. 2A-1 shows a class diagram corresponding to some embodiments of the present invention. FIGS. 2A-2 and 2A-3 show some data and methods associated with the classes of FIG. 2A-1. The invention is not limited to the class structure of FIGS. 2A-1, 2A-2 and 2A-3 or to object oriented programming.

As is known, a class may represent an entity. In the class description below, classes are sometimes spoken of as if there the corresponding entities. For example, an EDL class 110D can be spoken of as an EDL 110. Sometimes, the same reference numeral is used for the class and the corresponding entity.

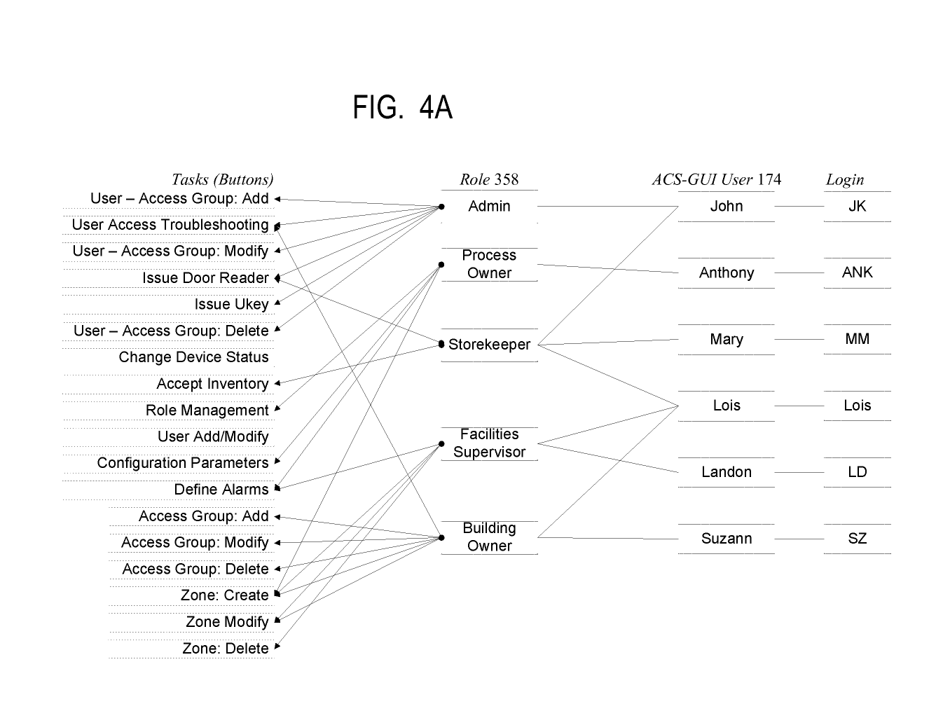

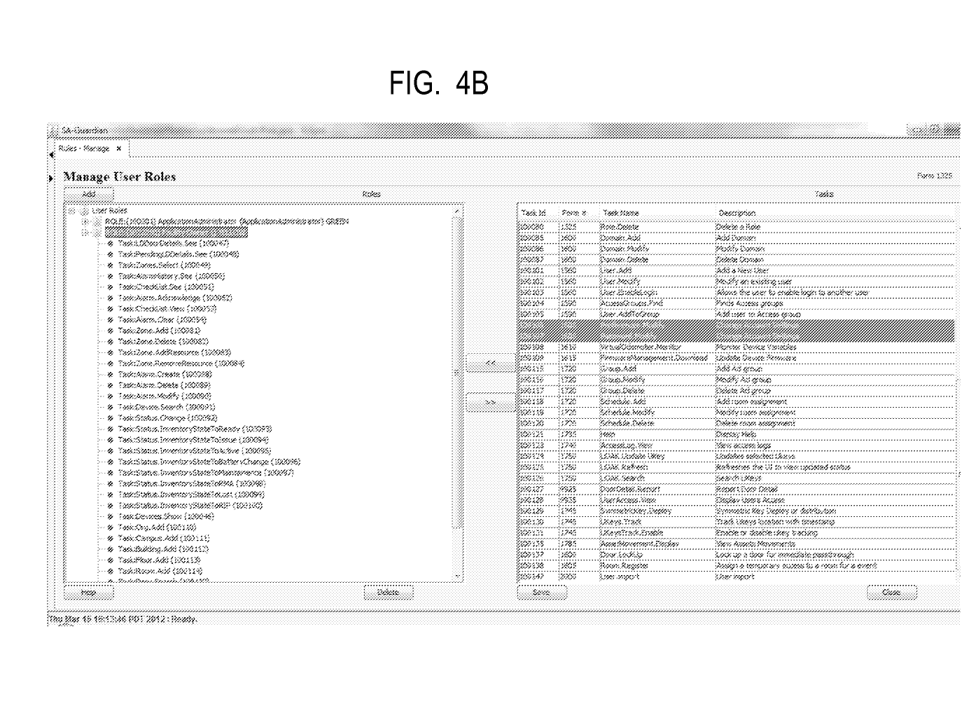

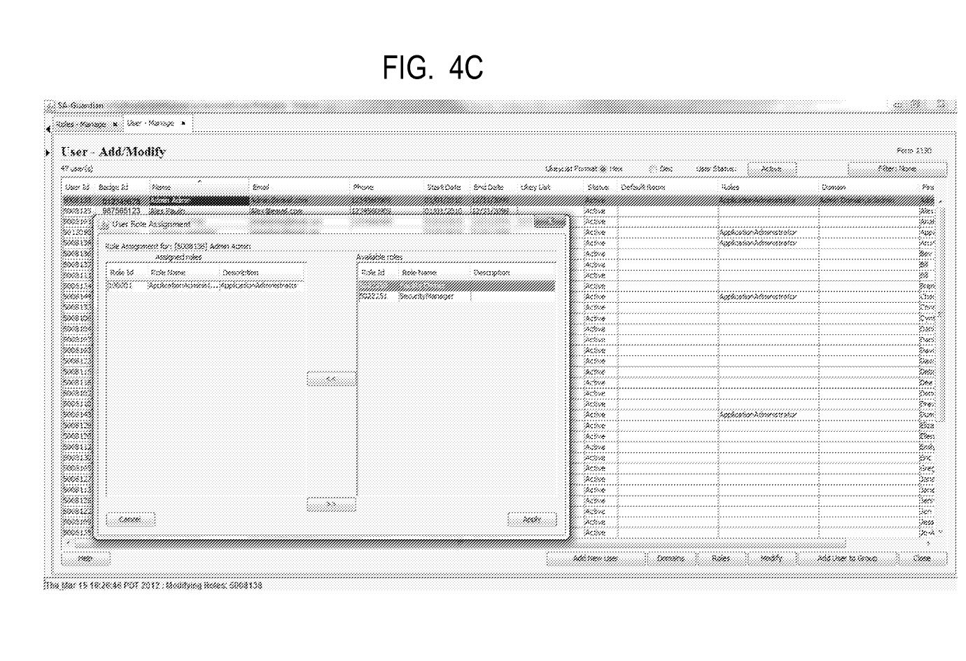

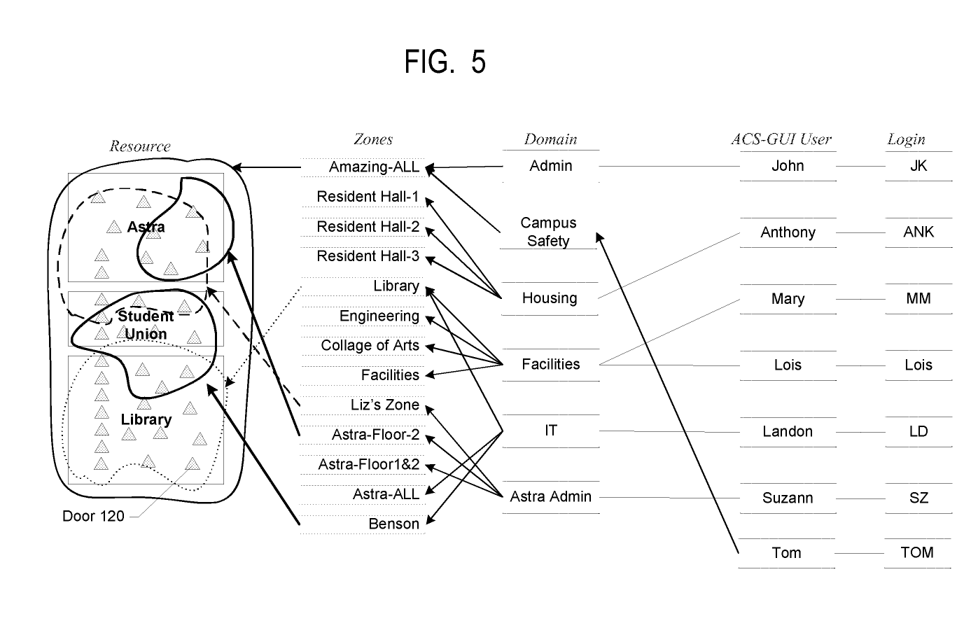

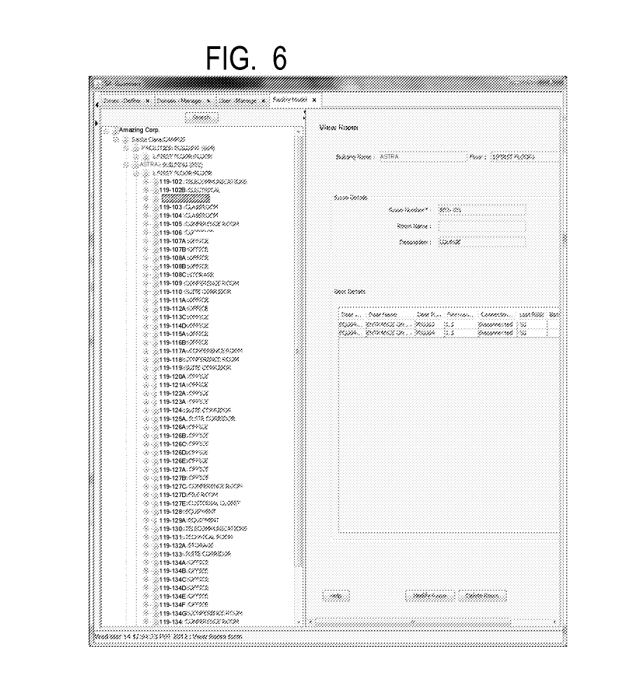

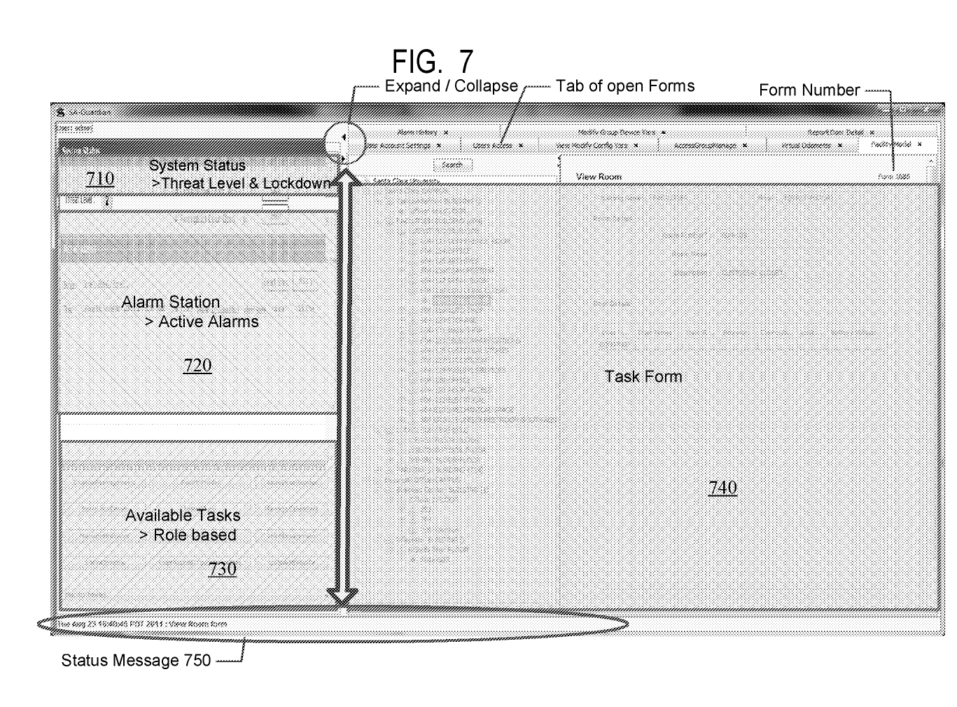

The classes of FIGS. 2A-1, 2A-2, 2A-3 include:
a. Walled polygon (WP) 310: This class models a civil construction feature whose boundary is defined as a polygon. The polygon edges approximately correspond to the boundary. It is a super-class (i.e. it has sub-classes derived from it; sub-class associations are shown by triangular arrows in Universal Modeling Language).
b. Organization (or Facility) 314: It models a logical entity (e.g. business or corporation) that may have one or more campuses. Please refer to FIG. 6.
c. Campus 318: Is a (subclass of) walled polygon, comprising one or more buildings that do not overlap each other. Please refer to FIG. 6.
d. Building 322: is a walled polygon encompassing civil construction, comprising one or more floors (modeled as 326), etc. The buildings do not overlap each other. Please refer to FIG. 6.
e. Floor 326: is a walled polygon encompassing civil construction that partitions the area into rooms, halls, corridors, etc., that do not overlap each other. Please refer to FIG. 6.
f. Room 330: This class models the smallest atomic walled polygon satisfying the property that different polygons of the same class do not overlap each other. Halls, parking lots, corridors etc. are each modeled similar to a room, and hereafter they are commonly referred as room. Please refer to FIG. 6.
g. Door 120D: The entrance (a section of walled polygon) through which a person enters or leaves a room or building. A door 120 is an example. A door may or may-not have a door lock (e.g. 110) to control people who may access the room or building. Please refer to FIG. 6.
2. Device 340: Is a super-class. An electronic or electro-mechanical device that communicates with Application Software (AS) 170. Examples include:
   a. EDL 110D: Represents an electronic door lock 110. EDL 110 communicates with E-Key 140 to determine access to the door 120; it also communicates with AS Server 170 to:
      1. Receive command messages from AS server 170 and respond with response messages.
      2. Provide to AS server 170 asynchronous event reports and alarm reports.
   b. Router 150D: Represents a communication device (e.g. router 150) that provides connectivity between AS and other devices like:
      i. EDL 110
      ii. E-Keys 140
      iii. Other routers 150
      iv. Locators 160
   c. E-key 140D: Represents an electronic key 140. Examples of e-keys 140 include card keys, key-fobs (e.g. magnetic stripe card, passive RFID, active RFID, ID chip (including SMART CHIP) with galvanic contacts, or other types). An E-Key 140 is carried by a user 140U. The E-Key communicates with an EDL 110. Some types of E-keys can also communicate with Routers 150 and Locators 160.
   d. Locator 160D: Represents a locator 160. It is a superclass. In some embodiments, a locator is similar to an EDL without a lock mechanism to control. The locator simply communicates with an e-key 140 and gets RSSI information, and reports it to the application software server 170 via a router device.
3. Door Lock (not shown in FIG. 2A-1): is a device that controls people's access to a walled polygon at a given moment of time. A Door lock could be purely mechanical or could be an EDL.
4. Resource 350: A logical entity to represent
   a. Walled polygon
   b. Devices with fixed locations (i.e. all devices except E-Keys).
5. Zone 354 enables a user 174U to aggregate a collection of devices that are specified by a collection of resources 350. Thus a Zone that corresponds to all of Floor 1 and 3 of a Building, will comprise all EDLs 110 and routers 150 and locators 160 that have been installed on floors 1 and 3 of the building. Please refer to FIG. 5.
   a. Zones could be of two types:
      i. Private: This type of zone is visible only to user 174U who created it, and could only be used by its creator.
      ii. Public: This type of zone is globally visible to all the users 174U. But only the zone creator can change the definition of the zone.
   b. FIG. 2B shows a private zone—MyZone
      i. MyZone has two types or resources
         1. devices (Routers 150, shown as R: [800001] and R: [800002])
         2. Walled Polygon (Rooms 330, shown as [5007575] etc.).
      MyZone aggregates 6 devices in total: two Routers 150 and four EDLs 110 (DR: [5008622] etc.) from the two rooms.
   c. The resources 350 in a zone 354 can be heterogeneous, and a zone 354 can have any number of resources 350 in it. The collection of resources 350 can be arbitrary and need not be linear or sequential.
   d. Zone 354 is a logical construct and does not need to follow physical layout of rooms etc.
   e. Different zones 354 may overlap with each other or coincide, i.e. the same resource may be present in multiple zones. Since zone 354 is a logical structure, it can be edited at run time, and in particular a zone 3554 can be created or deleted, and resources can be added to the zone or removed from the zone, at run time.
6. Alarm (not shown in FIG. 2A-1): Alarm is a notification of an event or situation which has occurred in the vicinity of the facility and requires attention to solve the issue.
   a. Alarms can be of many categories. Typically the severity is used as means to classify alarm types as:
      i. Human Safety
      ii. Facility Safety
      iii. Instrument Safety
   b. User 174U can specify what kind of events could be considered as alarm. User 174U can also define its severity by specifying its category.
   c. User 174U or 140U can respond to the alarm only if the user is authorized to do so. The authorization is given to the user by assigning to the user an appropriate role 358 (discussed below) corresponding to Alarm handling tasks 362 in the Application Software 230.
7. Role 358: Is a collection of Tasks (actions) 362 that are logically grouped (as appropriate) to be later assigned to people who need it as part of their job responsibility. See FIGS. 4A, 4B and 4C. Each action is specified by a corresponding Task 362.
   a. User 174U may have zero or more roles 358.
   b. One role 358 can be assigned to multiple users 174U, 140U.
   c. Each role may 358 optionally have a “Lockdown-Priority”.
8. Lockdown-Priority: Is the order of access privilege during “Lock Down” to respond to a threat situation.
   a. E.g. during Lockdown ordinary users 140U with their E-Keys 140 are prevented from gaining access to rooms 330; however, Emergency Responders, i.e. users 140U that have been assigned high priority, continue to have access to the rooms 330 via their E-Keys 140.
9. Task 362: Is an atomic action or a specific piece of work. See FIGS. 4A and 4B. All the tasks 362 can be performed using GUI Forms 370 by clicking a button 374 on the GUI form that is allocated for the task 362. Thus, accepting responsibility to respond to an alarm, issuing an E-key 140, or giving a person 140U access to a room 330 can be considered as tasks 362 and can be performed by clicking respective buttons ‘Accept Alarm’, ‘Issue E-key’ and ‘Add User to Access Group’ on the GUI forms.
   a. A task 362 can be a part of one or more roles 358.
   b. When a user 174U adds a task 362 to role(s) 358 of a particular user 140U or 174U, the task addition permits the particular user 140U or 174U to click the button 374 on the GUI form 370 to perform the atomic action described as the task 362.
10. The scope of the task may be decided using Domain 380 (described below).
   a. For example, in some embodiments, a user 174U is allowed to ‘Accept Alarm’ (task 362) only for Library building 322 but the same user 174U may be disallowed to ‘Accept Alarm’ for Office building 322. This scoping is done as per configuration of “Alarm Domain” 380 described below. This is exemplary and does not limit the scope of this invention.
   b. In another example, a user 174U is allowed to perform ‘Add User to Access Group’ (task 362) only for Business School building 322 but the same user 174U is not allowed to ‘Add User to Access Group’ (task 362) for Engineering School building 322. This scoping is done as per configuration of “ACL Domain” 380 described below. This is exemplary and does not limit the scope of this invention.
11. Domain 380 controls the ability of a user 174U to perform tasks 362 of different types. Please refer to FIG. 5.
   a. The task types include, for example:
      i. Tasks 362 that are related to managing access to rooms 330.
      ii. Tasks 362 that are related to managing Alarms.
   b. Domain 380 is a collection of one or more public zones 354. FIG. 2C shows that the resources 350 in the domain 380 are the collection of all the resources from all the zones 354 in it. The pop-up “Devices under Domain: 100443” shown in FIG. 2C appears when user 174U clicks “Devs”. The pop-up lists all the devices 340 that are within zones 354 corresponding to the Domain 380.
   c. Domains 380 can be of various types. Following are the two types in accordance with above examples. (This is exemplary and does not limit the scope of this invention).
      i. Access Domain: This type of domain if assigned to a user 174U. The assignment gives the user an authority to grant/remove/modify the access to people 140U to the rooms 330 (via EDLs 110) falling under this domain. This assignment does not give the user 174U authority to grant/remove/modify the access to any resources outside the domain.
      ii. Alarm Domain: This type of domain if assigned to a user 174U or 140U. This assignment gives the user an authority to respond to an alarm originating from the devices 340 falling under this domain.
   d. Domain 380 aggregates the devices 340 falling under its zones 354. Unlike zones 354, domains 380 can be assigned to a user (attached with user) 140U or 174U to control or relax the user's privileges. FIG. 2D shows one Alarm Domain and one Access Domain that are assigned to a user.
   e. Domain 380 is a logical construct and does not need to follow physical layout of rooms etc.
   f. Domains 380 may overlap or coincide with each other. Thus the same zone(s) can be simultaneously present in multiple domains 380. Domain 380 is a logical structure and therefore can be edited at run time: domains can be created or deleted, and zones 354 can be added to a domain or removed from a domain, at run time.
   g. Some advantages of defining Domain 380 as a collection of Public Zones 354 are:
      i. Instead of managing (and keeping current) each of a giant collection of devices 340 (or resources 350), the Domain construct allows partitioning the devices or resources into logical groups depending on user preferences, and allows assigning properties to a whole group rather than to each individual device or resource in the group.
      ii. The Domain construct allows reusability of Zones definition for matters that not domain specific; i.e. a Zone construct can be used for purposes unrelated to domains. For example, a user 174U may click on a zone to display all devices in the zone. Also, a zone does not have to be part of a domain.
      iii. The Domain construct can be associated to any number of users 174U to allow such users to manage the associated devices or resources without allowing such users to view or manage other devices or resources.
12. Access Control List (ACL) 130: Is a list of users 140U and their access rules that is stored in AS and on EDL 110. These rules determine whether a user 140U has access to a particular room 330 or other walled polygon at a given point of time. Access control list 130 is a highly reusable construct (can include information shared by different users).
   a. ACL 130 is aggregated of:
      i. ACL Schedule (Room Assignment) 394 (FIG. 2A-1). Each Room Assignment is specified as time of allowed access, for a specific room 330 (or other walled polygon), and is described using:
         1. Days of week when access is allowed
         2. Start date-end date when access is allowed
         3. Start time of day-end time of day when access is allowed during each of the days of week
      ii. Access Group 234: (see FIGS. 2E and 3A)
         1. Is a collection of ‘ACL schedules’ (room assignments) 394.
         2. Has its own Start and End dates.
         The allowed dates of accessing a specific walled polygon are the set-theory intersection of:
         a. allowed dates in the ACL schedule for the walled polygon; and
         b. allowed dates in the Access Group 234.
         3. Access Group 234 could be associated with a Calendar 238 that may further limit the allowed dates.
      iii. User access group enrollment (see FIGS. 3A and 3B): This method enrolls (adds) user 140U to an access group 234.
13. Calendar 238: Could be described as:
   a. List of Holidays (or “Blackout Days”) when access shall not be granted to a user 140U even if the user is a member of an Access Group 234 which is associated with the Calendar and which allows access for that day of week and time of day.
   b. List of ‘Workdays’ (Whiteout days) when access is allowed to any user 140U who is a member of at least one access group 234 associated with the Calendar.
   c. Calendar may optionally be scoped by:
      i. Start date
      ii. End date
14. Other constructs shown in FIG. 2A-1 include class SAUser 390 which models a user 140U or 174U: SAUser's subclass 174UD models a user 174U; subclass 140UD models a user 140U.
15. Holiday class 398 is associated with Calendar class 238 which is associated with Access Group class 234.
16. Some embodiments of the invention thus allow greater flexibility in describing access rules. In particular, an Access Group can be made valid for only a limited number of days.
17. Some embodiments allow calendars 238 to be used in many flexible ways. Thus different Access Groups 234 cab be associated with different Calendars 238. For example, Access Group 234 for Sports classes may have a calendar schedule depending on a team's tournament registration; while Access Group 234 for academic classes may have a different Calendar 238, which in turn may be different from the Calendar 238 for Access Group 234 for religious classes.
18. FIG. 7 shows a GUI screen format for an ACS-GUI application executed by a computer 174 in some embodiments. The screen is split into sub-panels:
   a. Status panel 710 where a snapshot of overalls system status is displayed, including:
      i. Current security threat level,
      ii. Lockdown status etc.
   b. Alarm panel 720, that shows Alarms that are active (not yet cleared), for devices 340/resources 350 corresponding to user's Alarm Domain 380.
   c. Available Tasks panel 730, that shows all the available tasks 362 that user 174U can initiate. Scoped by user's roles 358.
   d. Task sub-panel 740 that displays GUI for a chosen task 362.
      i. Many tasks 362 could be in progress. In which case the tasks are shown as tabs.
   e. The bottom has a space for Status message 750 corresponding to the success or failure of previous task 362 that was executed.
19. FIG. 8 is a sample GUI display of the ACS GUI application executed by computer 174.

### EDL Side Implementation of ACS:

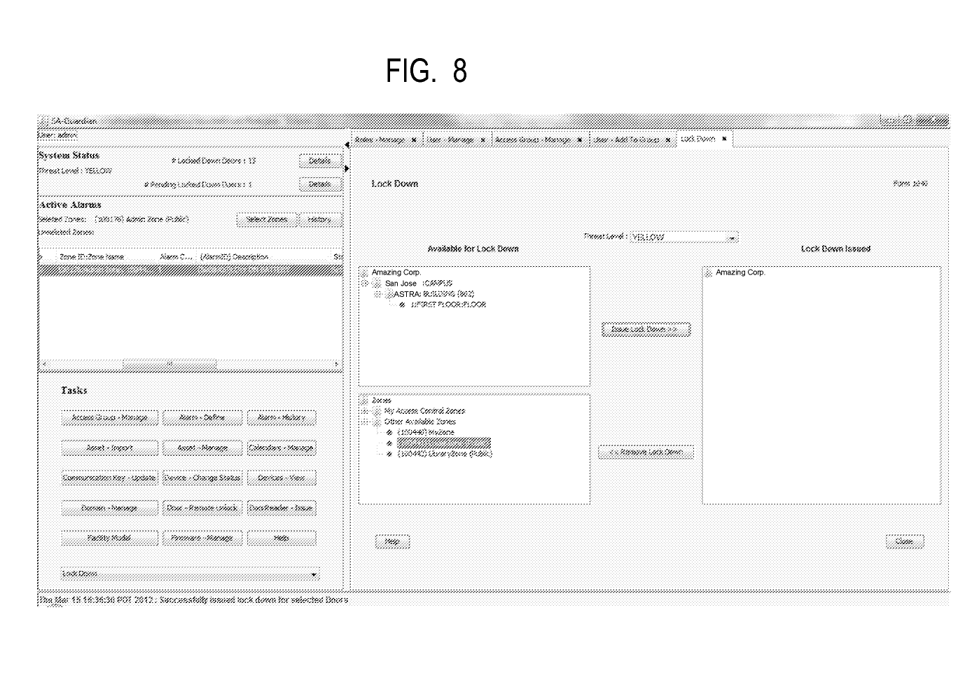

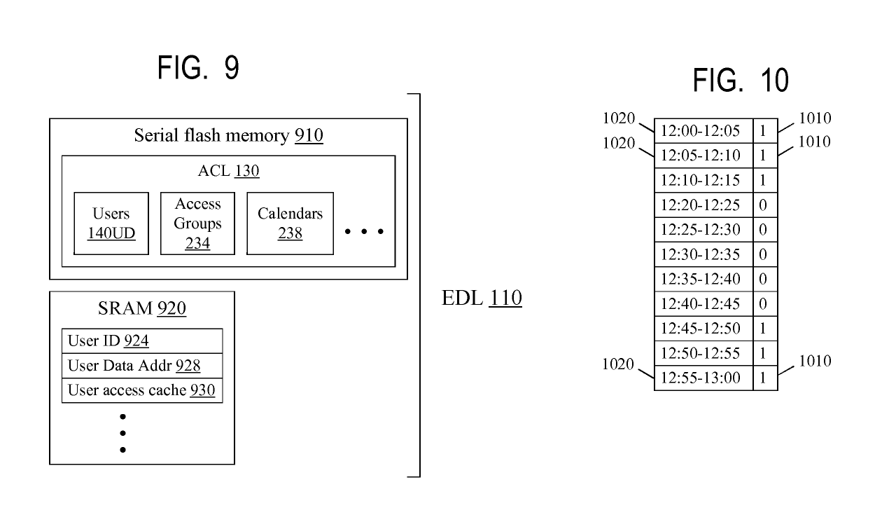

1. In an EDL embodiment shown in FIG. 9, the ACL 130 is stored in serial flash memory 910, but in addition to that the EDL has parallel SRAM (Static Random Access Memory) 920. SRAM 920 provides fast random access, while the flash memory 910 provides cost effective bulk storage. SRAM 920 is used to store the data needed for fast user lookup. SRAM 920 contains a cache of each user 140U's access rules for the present time and the near future.
2. The data is structured such that the content of SRAM 920 can be constructed from the content of the flash memory 910 upon power-up.
3. In the preferred embodiment a user entry in SRAM 920 contains the following information:
   a. User 140U's user ID 924 (note the field “userId” in SAUser 390 in FIG. 2A-3);
   b. Information (not shown) to manage a balanced binary tree (left pointer, right pointer, and balance factor).
   c. Address 928 of the user 140U's data in flash memory 910.
   d. An access cache 930.
4. The access cache 930 for a single user 140U can be implemented as a bit field (see FIG. 10) where each bit 1010 represents a fixed period of time shown at 1020. In FIG. 10, each period 1020 is five minutes, but other period durations can also be used (one minute for example). The value of the corresponding bit 1010 determines whether the user 140U has access during the time period 1020. In the example of FIG. 10, the user has access before 12:15 and then again starting at 12:45. If the current time is within a period 1020, then the determination whether user 140U has access at the current time can be made simply by testing corresponding bit 1010.
5. Before the time period represented by the access cache is over (i.e. before 13:00 in the example of FIG. 10), the cache 930 is refreshed. This operation is possible with a single traversal through the entire ACL data structure 130. For example, the following pseudo-code can be used:
   Table 1: Refresh of Cache 930
   1. For each user 140U:
      1.1 Clear access cache to 0 (i.e. set all bits 1010 to 0).
   2. For each Access Group 234:
      2.1 Evaluate access rules for group 234 for the time periods to be cached and generate a bit mask in the same format as the users' access cache 930. In other words, generate a bit mask like in FIG. 10 which determines, for each time period 1020 to be cached, the corresponding bit 1010 value for the access group (“1” if the access group has entry in this time period, and “0” otherwise).
      2.2 For each user 140U in the group 234:
         2.2.1 Perform a bit-wise OR between the group's bit mask determine at 2.1 and the user's bit mask 930 and write back the result to the user's bit mask 930. (The bit mask is initially zero due to step 1.1.)
6. End of Table 1
7. For the access cache 930 to remain functional during an update the cache 930 can be split into two parts (double-buffering). While one part is updated the other part is active and can be used for lookups by EDL 110.

### Data Integrity Verification

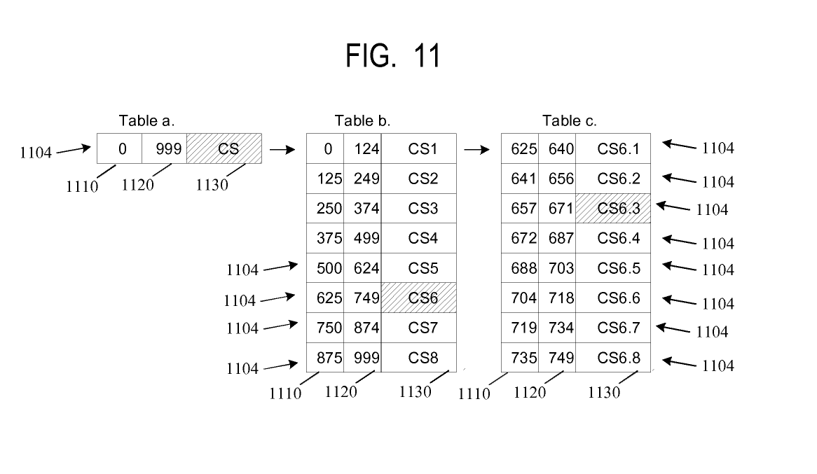

8. As mentioned above, there need to be an efficient method to verify the integrity of an ACL by comparing it to a reference. In some embodiments of the present invention, instead of transmitting the entire ACL to server 170, the door reader 110 computes a checksum of the ACL and transmits the checksum to the server. The server 170 computes the checksum on the server's version of the ACL using the same rules and if the server arrives at the same checksum, then the server can assume that the ACLs are in sync.
9. The ACL is stored as arrays of records of different types: Users 140U, Access Groups 234, Calendars 238, etc. The algorithm that computes the checksum on each of EDL 110 and server 170 performs the following steps:
   Table 2: Checksum Computation
   a. Initialize the checksum algorithm.
   b. Prepare to traverse all records that are in the ACL in a predefined order (for example sorted by ID), and locate the first record.
   c. Serialize the current record to a binary interpretation.
   d. Update the checksum with the data of the serialized record.
   e. Advance to next record and go to step c, or return checksum when done.
   END OF TABLE 2
10. With the algorithm of Table 2, as long as the door reader 110 and the server 170 have the same rules regarding the order of records and the serialization, and generally have the same checksum algorithm (Table 2), they will arrive at the same checksum if the ACL is the same.
11. When the checksums do not match, there needs to be a way to locate the record or records that are different. This can be achieved by dividing all records into ranges and computing a checksum for each range. FIG. 11 illustrates this process. In this example, a checksum computation over a range of records is illustrated by a table row 104; in row 104, numbers 1110, 1120 are the numbers of the first and last records in the range of records; checksum 1130 is the checksum computed on this range. The process is as follows:
Table 3: Locate non-matching records
(a) First, server 170 requests an EDL 110 to provide the EDL's checksum of the entire ACL (in FIG. 11, Table a, the ACL has 1000 records, numbered 0 through 999). The server then computes the same checksum on the server's ACL. As shown in FIG. 11 Table a, the checksums 1130 do not match (hatching of checksum 1130 indicates mismatch).
(b) Then the server requests the EDL 110 to split the ACL into a number of ranges (8 ranges in the example of FIG. 11 Table b), and provide the checksum for each range. The server computes these checksums on the server's ACL. The checksums are shown as CS1 through CS8. All the checksums match except for CS6, which is the checksum for Range 6 consisting of records 625 through 749.
(c) Range 6 is now split up into smaller sub-ranges (FIG. 11 Table c), and the server requests the EDL 110 to provide the checksums for these sub-ranges. The server also computes the checksum for these sub-ranges on the server's ACL. In the example of FIG. 11 Table c, all the checksums match except for Range 3 consisting of records 657-671.
(d) This process continues until the offending record is found, or until the range is narrow enough that all records in the range can be transmitted by the EDL 110 to the server 170 for comparison.
END OF TABLE 3

### Activation Mode

1. With door readers 110 that provide hand-free access, it is possible that different users 140U have different requirement with respect to the door reader's behavior:
   a. A user 140U in a wheelchair may require the reader 110 to unlock from a longer distance than would be required for other people.
   b. If the door 120 is equipped with an automatic door opener (ADO, not shown), it may be desirable to use the ADO only for users 140U who have trouble opening the door by themselves, but not for everybody.
   c. A user 140U who has a master key 140 may not want that doors unlock unnecessarily as the user is walking by, and would therefore prefer a shorter activation distance and/or a longer time delay between the EDL 110 detecting the key 140 and unlocking the lock.
2. These requirements can be accommodated by personalized access modes that can be stored as part of the user record in the ACL. Using such personalized access modes, the default behavior of a door reader 110 can be changed in the following ways:
   a. Adjustment of the activation distance based on the user 140U, either by specifying a particular distance for the user or by specifying an offset to a default distance.
   b. Enabling or disabling of the automatic door opener function.
   c. Enabling or disabling the requirement for the user 140U to be in the proximity of the reader 110 for a minimum time for the reader to unlock.
   d. Requiring some interaction with the reader 110, such as entering a PIN code.

Some embodiments of the invention provide a method for operating a computer system to configure secure access to one or more resources. The computer system can be, for example, application server 170 or computer 174 or both. The access is controlled by a plurality of electronic devices, e.g. EDLs 110. The method comprises:
Obtaining, by the computer system, data which identify the electronic devices and also identify one or more device sets (e.g. domains 380), each device set comprising zero or more of the electronic devices, at least one device set comprising a plurality of the electronic devices;

For each said device set, the computer system:
receiving a command to perform an operation on the device set (e.g. to associate an access group with the domain); and
performing the operation on the device set.

For example, if the computer system is AS server 170, then the operation performed by the computer system may include generating suitable ACLs and sending them to EDLs 110. If the computer system is a computer 174, the operation may include communicating with the AS server 170 to cause the AS server to generate the ACLs and send them to EDLs 110.

In some embodiments, for at least one device set, the command specifies at least one first user (e.g. 174U), and the operation comprises causing the access control system to allow the first user to configure each electronic device in the device set and/or to receive information about configuration of each electronic device in the device set.

In some embodiments, configuring an electronic device comprises at least one of:

specifying which user or users (e.g. 140U) are allowed and/or not allowed access controlled by the device;

specifying when the device is to allow and/or disallow access.

In some embodiments, for at least one device set, the command specifies at least one first user (e.g. 174U), and the operation comprises causing the access control system to allow the first user to configure alarm handling for alarms originating from any device in the device set.

In some embodiments, configuring alarm handling comprises at least one of:

specifying kinds of events that are considered an alarm or not considered an alarm;

specifying an alarm severity;

specifying which user or users (e.g. 140U) are allowed and/or disallowed to respond to an alarm via the access control system.

In some embodiments, responding to an alarm via the access control system comprises issuing an alarm-handling computer command (e.g. by clicking a button 374) to the access control system.

Some embodiments provide a method for operating a computer system (e.g. 170 or 174) to configure secure access to one or more resources, the access being controlled by a plurality of electronic devices, the method comprising:

obtaining, by the computer system, data which specify:
one or more schedules (e.g. room assignments 394) each of which specifies when access controlled by one or more of the devices is allowed and/or disallowed; and
a plurality of calendars, each calendar specifying one or more days when access controlled by one or more of the devices is allowed and/or disallowed regardless of the one or more schedules;

operating the computer system to configure the devices to provide access in accordance with the one or more schedules and the plurality of calendars.

In some embodiments:

the data associates each of one or more users (e.g. 140U) with one or more calendars;

configuring the devices to provide access comprises the computer system associating each of the one or more users with the one or more calendars to provide access to each of the one or more users in accordance with the one or more calendars.

In some embodiments, the one or more users comprise a plurality of users, and at least two of the users are associated with different calendars.

In some embodiments, the data specify, for at least one schedule, a time when the schedule is in effect (e.g. start date (stDate) and end date (endDate) in room assignment 394), and the computer system is operated to configure the devices to provide access in accordance with the time when the schedule is in effect.

Some embodiments provide a method for controlling access to a resource, the method comprising:

receiving, by an electronic device (e.g. EDL 110) which controls access to the resource, data over a computer network, the data specifying:
one or more schedules (e.g. room assignments 394) each of which specifies when access controlled by the device is allowed and/or disallowed; and
a plurality of calendars, each calendar specifying days when access controlled by the device is allowed and/or disallowed regardless of the one or more schedules;

operating the device to provide access in accordance with the one or more schedules and the plurality of calendars.

Some embodiments include a method performed by an electronic device (e.g. EDL 110) that provides, to one or more users, secure access to a resource, the method comprising:

storing, in the device, access control data (e.g. room assignments, calendars, etc.) which define, for each user, when the user is to have access;

keeping track of a current time;

detecting the user;

determining, from the access control data, whether access is to be provided to the detected user at the current time; and

causing the access to be provided or not provided based on the determining operation (e.g. unlocking the lock or keeping it locked);

wherein the device comprises a first memory (e.g. flash 910) and a second memory (e.g. SRAM) faster than the first memory (the invention is not limited to particular memory types);

wherein storing access control data comprises:

storing first access control data in the first memory, wherein the first access control data define, for each user, when the user is to have access;

storing second access control data in the second memory, wherein the second access control data is relevant to the current time to define, for each of one or more of the users, whether the user is to have access in one or more time periods (e.g. 1020) comprising the current time;

wherein upon detecting the user whose time-related information is in the second memory, the determining operation uses the second access control data in the second memory.

Some embodiments further comprise, as the current time advances towards an end of the one or more time periods, refreshing the second access control data in the second memory from the first access control data to cause the second access control data to define, for each of one or more of the users, whether the user is to have access in one or more time periods comprising a future time. The refreshing can be done, for example, as in Table 1.

Some embodiments provide a method for determining integrity of access control data stored and used by an electronic device (e.g. EDL 110) that controls access to a resource, the method comprising:

storing, by a computer system (e.g. 170), access control data for the device;

receiving, from the device, one or more first checksums of one or more sets of the access control data stored by the device, without receiving all of the one or more sets of the access control data stored by the device (e.g. the first checksums can be generated by EDL 110);

determining, from the access control data stored by the computer system, one or more second checksums of one or more sets of the access control data stored by the computer system (e.g. the second checksums can be generated by server 170);

the computer system matching the one or more first checksums with the one or more second checksums to determine integrity of the access control data stored by the device.

In some embodiments, in the matching operation, equality between the one or more first checksums and the respective one or more checksums indicates integrity of the access control data stored by the device, and inequality indicates lack of integrity.

The invention includes, but not limited to, the following numbered aspects.

Aspect 1. A method for operating a computer system to configure secure access to one or more resources, the access being controlled by a plurality of electronic devices, the method comprising:

obtaining, by the computer system, data which identify the electronic devices and also identify one or more device sets, each device set comprising zero or more of the devices, at least one device set comprising a plurality of the devices;

for each said device set, the computer system:
receiving a command to perform an operation on the device set; and
performing the operation on the device set.

Aspect 2. The method of aspect 1 wherein for at least one device set, the command specifies at least one first user, and the operation comprises causing the access control system to allow the first user to configure each device in the device set and/or to receive information about configuration of each device in the device set.

Aspect 3. The method of aspect 2 wherein configuring a device comprises at least one of:

specifying which user or users are allowed and/or not allowed access controlled by the device;

specifying when the device is to allow and/or disallow access.

Aspect 4. The method of aspect 1 wherein for at least one device set, the command specifies at least one first user, and the operation comprises causing the access control system to allow the first user to configure alarm handling for alarms originating from any device in the device set.

Aspect 5. The method of aspect 4 wherein configuring alarm handling comprises at least one of:

specifying kinds of events that are considered an alarm or not considered an alarm;

specifying an alarm severity;

specifying which user or users are allowed and/or disallowed to respond to an alarm via the access control system.

Aspect 6. The method of aspect 5 wherein responding to an alarm via the access control system comprises issuing an alarm-handling computer command to the access control system.

Aspect 7. A computer system configured to perform the method of aspect 1.

Aspect 8. The computer system of aspect 7 wherein in the method, for at least one device set, the command specifies at least one first user, and the operation comprises causing the access control system to allow the first user to configure each device in the device set and/or to receive information about configuration of each device in the device set.

Aspect 9. The computer system of aspect 8 wherein in the method, configuring a device comprises at least one of:

specifying which user or users are allowed and/or not allowed access controlled by the device;

specifying when the device is to allow and/or disallow access.

Aspect 10. The computer system of aspect 7 wherein in the method, for at least one device set, the command specifies at least one first user, and the operation comprises causing the access control system to allow the first user to configure alarm handling for alarms originating from any device in the device set.

Aspect 11. The computer system of aspect 10 wherein in the method, configuring alarm handling comprises at least one of:

specifying kinds of events that are considered an alarm or not considered an alarm;

specifying an alarm severity;

specifying which user or users are allowed and/or disallowed to respond to an alarm via the access control system.

Aspect 12. The computer system of aspect 11 wherein in the method, responding to an alarm via the access control system comprises issuing an alarm-handling computer command to the access control system.

Aspect 13. A computer readable memory comprising software operable to cause a computer system to perform the method of aspect 1.

Aspect 14. The computer readable memory of aspect 13 wherein in the method, for at least one device set, the command specifies at least one first user, and the operation comprises causing the access control system to allow the first user to configure each device in the device set and/or to receive information about configuration of each device in the device set.

Aspect 15. The computer readable memory of aspect 14 wherein in the method, configuring a device comprises at least one of:

specifying which user or users are allowed and/or not allowed access controlled by the device;

specifying when the device is to allow and/or disallow access.

Aspect 16. The computer readable memory of aspect 13 wherein in the method, for at least one device set, the command specifies at least one first user, and the operation comprises causing the access control system to allow the first user to configure alarm handling for alarms originating from any device in the device set.

Aspect 17. The computer readable memory of aspect 16 wherein in the method, configuring alarm handling comprises at least one of:

specifying kinds of events that are considered an alarm or not considered an alarm;

specifying an alarm severity;

specifying which user or users are allowed and/or disallowed to respond to an alarm via the access control system.

Aspect 18. The computer readable memory of aspect 17 wherein in the method, responding to an alarm via the access control system comprises issuing an alarm-handling computer command to the access control system.

Aspect 18A. A computer readable memory comprising a data structure comprising:

data which identify electronic devices which control secure access to one or more resources;

data which identify one or more device sets, each device set comprising zero or more of the devices, at least one device set comprising a plurality of the devices; and

for at least one device set, data which identify at least one first user as being allowed to perform at least one of:

(A) configure each device in the device set and/or to receive information about configuration of each device in the device set;

(B) configure alarm handling for alarms originating from any device in the device set.

Aspect 18B. The computer readable memory of aspect 18A wherein for at least one device set and at least one first user, the data identify the first user as being allowed to perform the operation (A), wherein configuring a device comprises at least one of:

specifying which user or users are allowed and/or not allowed access controlled by the device;

specifying when the device is to allow and/or disallow access.

Aspect 18C. The computer readable memory of aspect 18B wherein configuring a device comprises at least one of:

specifying which user or users are allowed and/or not allowed access controlled by the device;

specifying when the device is to allow and/or disallow access.

Aspect 18D. The computer readable memory of aspect 18A wherein for at least one device set and at least one first user, the data identify the first user as being allowed to perform the operation (B), wherein configuring alarm handling comprises at least one of:

specifying kinds of events that are considered an alarm or not considered an alarm;

specifying an alarm severity;

specifying which user or users are allowed and/or disallowed to respond to an alarm via the access control system.

Aspect 18E. The computer readable memory of aspect 18D wherein responding to an alarm via the access control system comprises issuing an alarm-handling computer command to the access control system.

Aspect 19. A method for operating a computer system to configure secure access to one or more resources, the access being controlled by a plurality of electronic devices, the method comprising:

obtaining, by the computer system, data which specify:
one or more schedules each of which specifies when access controlled by one or more of the electronic devices is allowed and/or disallowed; and
a plurality of calendars, each calendar specifying one or more days when access controlled by one or more of the electronic devices is allowed and/or disallowed regardless of the one or more schedules;

operating the computer system to configure the electronic devices to provide access in accordance with the one or more schedules and the plurality of calendars.

Aspect 20. The method of aspect 19 wherein:

the data associates each of one or more users with one or more calendars;

configuring the devices to provide access comprises the computer system associating each of the one or more users with the one or more calendars to provide access to each of the one or more users in accordance with the one or more calendars.

Aspect 21. The method of aspect 20 wherein the one or more users comprise a plurality of users, and at least two of the users are associated with different calendars.

Aspect 22. The method of aspect 19 wherein the data specify, for at least one schedule, a time when the schedule is in effect, and the computer system is operated to configure the devices to provide access in accordance with the time when the schedule is in effect.

Aspect 23. A computer system configured to perform the method of aspect 19.

Aspect 24. The computer system of aspect 23 wherein in the method:

the data associates each of one or more users with one or more calendars;

configuring the devices to provide access comprises the computer system associating each of the one or more users with the one or more calendars to provide access to each of the one or more users in accordance with the one or more calendars.

Aspect 25. The computer system of aspect 24 wherein in the method, the one or more users are operable to comprise a plurality of users, and at least two of the users are operable to be associated with different calendars.

Aspect 26. The computer system of aspect 23 wherein in the method, the data specify, for at least one schedule, a time when the schedule is in effect, and the computer system is operated to configure the devices to provide access in accordance with the time when the schedule is in effect.

Aspect 27. A computer readable memory comprising software operable to cause a computer system to perform the method of aspect 19.

Aspect 28. The computer readable memory of aspect 27 wherein in the method:

the data associates each of one or more users with one or more calendars;

configuring the devices to provide access comprises the computer system associating each of the one or more users with the one or more calendars to provide access to each of the one or more users in accordance with the one or more calendars.

Aspect 29. The computer readable memory of aspect 28 wherein in the method, the one or more users are operable to comprise a plurality of users, and at least two of the users are operable to be associated with different calendars.

Aspect 30. The computer readable memory of aspect 23 wherein in the method, the data specify, for at least one schedule, a time when the schedule is in effect, and the computer system is operated to configure the devices to provide access in accordance with the time when the schedule is in effect.

Aspect 31. A method for controlling access to a resource, the method comprising:

receiving, by an electronic device which controls access to the resource, data over a computer network, the data specifying:
one or more schedules each of which specifies when access controlled by the device is allowed and/or disallowed; and
a plurality of calendars, each calendar specifying days when access controlled by the device is allowed and/or disallowed regardless of the one or more schedules;

operating the device to provide access in accordance with the one or more schedules and the plurality of calendars.

Aspect 32. The method of aspect 31 wherein:

the data associates each of one or more users with one or more calendars;

operating the device to provide access comprises operating the device to provide access to each of the one or more users in accordance with the one or more calendars.

Aspect 33. The method of aspect 32 wherein the one or more users comprise a plurality of users, and at least two of the users are associated with different calendars.

Aspect 34. The method of aspect 31 wherein the data specify, for at least one schedule, a time when the schedule is in effect, and the device is operated to provide access in accordance with the time when the schedule is in effect.

Aspect 35. An electronic device for controlling access to a resource, the device being operable to perform the method of aspect 31.

Aspect 36. The device of aspect 31 wherein in the method:

the data associates each of one or more users with one or more calendars;

operating the device to provide access comprises operating the device to provide access to each of the one or more users in accordance with the one or more calendars.

Aspect 37. The device of aspect 36 wherein in the method, the one or more users are operable to comprise a plurality of users, and at least two of the users are operable to be associated with different calendars.

Aspect 38. The device of aspect 35 wherein in the method, the data specify, for at least one schedule, a time when the schedule is in effect, and the device is operated to provide access in accordance with the time when the schedule is in effect.

Aspect 38A. A computer readable memory comprising a data structure comprising:

data identifying a group of one or more schedules each of which specifies when access is allowed and/or disallowed to one or more resources, the access being controlled by one or more electronic devices; and

data associated with the group and identifying a plurality of calendars, each calendar specifying one or more days when access controlled by one or more of the electronic devices is allowed and/or disallowed regardless of the one or more schedules.

Aspect 38B. The computer readable memory of aspect 38A further comprising data associating one or more users with one or more calendars, each user being allowed or disallowed access to the one or more resources in accordance with the one or more calendars.

Aspect 38C. The computer readable memory of aspect 38B wherein the one or more users comprise a plurality of users, and at least two of the users are associated with different calendars.

Aspect 38D. The computer readable memory of aspect 38A wherein the data specify, for at least one schedule, a time when the schedule is in effect.

Aspect 39. A method performed by an electronic device that provides, to one or more users, secure access to a resource, the method comprising:

storing, in the electronic device, access control data which define, for each user, when the user is to have access;

keeping track of a current time;

detecting the user;

determining, from the access control data, whether access is to be provided to the detected user at the current time; and

causing the access to be provided or not provided based on the determining operation;

wherein the device comprises a first memory and a second memory faster than the first memory;

wherein storing access control data comprises:

storing first access control data in the first memory, wherein the first access control data define, for each user, when the user is to have access;

storing second access control data in the second memory, wherein the second access control data is relevant to the current time to define, for each of one or more of the users, whether the user is to have access in one or more time periods comprising the current time;

wherein upon detecting the user whose time-related information is in the second memory, the determining operation uses the second access control data in the second memory.

Aspect 40. The method of aspect 39 further comprising, as the current time advances towards an end of the one or more time periods, refreshing the second access control data in the second memory from the first access control data to cause the second access control data to define, for each of one or more of the users, whether the user is to have access in one or more time periods comprising a future time.

Aspect 41. An electronic device for performing the method of aspect 39.

Aspect 42. The electronic device of aspect 41 wherein the method further comprises, as the current time advances towards an end of the one or more time periods, refreshing the second access control data in the second memory from the first access control data to cause the second access control data to define, for each of one or more of the users, whether the user is to have access in one or more time periods comprising a future time.

Aspect 43. A method for determining, by a computer system, integrity of data stored and used by an electronic device that controls access to a resource, the method comprising the computer system performing operations of:

storing, by the computer system, access control data for the electronic device;

receiving from the device, by the computer system, one or more first checksums of one or more records of the access control data stored by the device, without receiving all of the one or more records of the access control data stored by the device;

determining by the computer system, from the access control data stored by the computer system, one or more second checksums of one or more records of the access control data stored by the computer system;

the computer system matching the one or more first checksums with the one or more second checksums to determine integrity of the access control data stored by the device.

Aspect 44. The method of aspect 43 wherein in the matching operation, equality between the one or more first checksums and the respective one or more checksums indicates integrity of the access control data stored by the device, and inequality indicates lack of integrity.

Aspect 45. The method of aspect 43 wherein, in case of a mismatch between at least one first checksum and a corresponding one second checksum which correspond to a plurality of records, the method further comprises:

receiving from the device, by the computer system, a plurality of new first checksums each of which is a checksum of a subset of the plurality of records of the access control data stored by the device;

determining by the computer system, from the subsets of the plurality of records of access control data stored by the computer system, a plurality of new second checksums each of which is a checksum of a subset of the plurality of records of the access control data stored by the computer system;

the computer system matching the one or more new first checksums with the one or more new second checksums to identify the one or more subsets lacking integrity.

Aspect 46. A computer system configured to perform the method of aspect 43.

Aspect 47. The computer system of aspect 46 wherein in the matching operation, equality between the one or more first checksums and the respective one or more checksums indicates integrity of the access control data stored by the device, and inequality indicates lack of integrity.

Aspect 48. The computer system of aspect 46 wherein in the method, in case of a mismatch between at least one first checksum and a corresponding one second checksum which correspond to a plurality of records, the computer system is operable to perform operations of:

receiving, from the device, a plurality of new first checksums each of which is a checksum of a subset of the plurality of records of the access control data stored by the device;

determining, from the subsets of the plurality of records of access control data stored by the computer system, a plurality of new second checksums each of which is a checksum of a subset of the plurality of records of the access control data stored by the computer system;

matching the one or more new first checksums with the one or more new second checksums to identify the one or more subsets lacking integrity.

Aspect 49. A computer readable memory comprising software operable to cause a computer system to perform the method of aspect 43.

Aspect 50. The computer readable memory of aspect 49 wherein in the matching operation, equality between the one or more first checksums and the respective one or more checksums indicates integrity of the access control data stored by the device, and inequality indicates lack of integrity.

Aspect 51. The computer readable memory of aspect 49 wherein in the method, in case of a mismatch between at least one first checksum and a corresponding one second checksum which correspond to a plurality of records, the software is operable to cause the computer system to perform operations of:

receiving, from the device, a plurality of new first checksums each of which is a checksum of a subset of the plurality of records of the access control data stored by the device;

determining, from the subsets of the plurality of records of access control data stored by the computer system, a plurality of new second checksums each of which is a checksum of a subset of the plurality of records of the access control data stored by the computer system;

matching the one or more new first checksums with the one or more new second checksums to identify the one or more subsets lacking integrity.

Aspect 52. A method for determining, by a computer system, integrity of data stored on a remote electronic device, the method comprising:

(a) the computer system receiving, from the electronic device, one or more first checksums of one or more records of the data stored by the device, without receiving all of the one or more records of the data stored by the device;

(b) the computer system determining, from a version of the data stored by the computer system, one or more second checksums of one or more records of the data stored by the computer system;

(c) the computer system matching the one or more first checksums with the one or more second checksums to determine integrity of the access control data stored by the device;

(d) in case of a mismatch between at least one first checksum and a corresponding one second checksum which correspond to a plurality of records, the computer system:

(d1) receiving, from the device, a plurality of new first checksums each of which is a checksum of a subset of the plurality of records of the data stored by the device;

(d2) determining, from the subsets of the plurality of records of the version of the data stored by the computer system, a plurality of new second checksums each of which is a checksum of a subset of the plurality of records of the version of the data stored by the computer system;

(d3) the computer system matching the one or more new first checksums with the one or more new second checksums to identify the one or more subsets lacking integrity.

Aspect 53. The method of aspect 52 further comprising, in case of a mismatch between at least one new first checksum and a corresponding one new second checksum which correspond to a plurality of records which is a sub-plurality of the plurality of operation (d), the computer system repeating operations (d1) through (d3) on the sub-plurality of records.

Aspect 54. A computer system configured to perform the method of aspect 52.

Aspect 55. The computer system of aspect 54 wherein in case of a mismatch between at least one new first checksum and a corresponding one new second checksum which correspond to a plurality of records which is a sub-plurality of the plurality of operation (d), the computer system is operable to repeat operations (d1) through (d3) on the sub-plurality of records.

Aspect 56. A computer readable memory comprising software operable to cause a computer system to perform the method of aspect 52.

Aspect 57. The computer readable memory of aspect 56 wherein in case of a mismatch between at least one new first checksum and a corresponding one new second checksum which correspond to a plurality of records which is a sub-plurality of the plurality of operation (d), the software is operable to cause the computer system to repeat operations (d1) through (d3) on the sub-plurality of records.

Aspect 58. A method performed by an electronic device storing data, to allow a remote computer system to determine integrity of the data, the method comprising:

(a) the electronic device sending, to the computer system, a checksum of a plurality of records of the data stored by the device;

(b) the device receiving, from the computer system, a request for a plurality of checksums each of which is a checksum of a sub-plurality of the plurality of records, the request being received upon the computer system discovering lack of integrity of the plurality of records based on the checksum in (a);

(c) the device sending the plurality of checksums to the computer system.

Aspect 59. The method of aspect 58 wherein the device is an electronic lock controlling access to a resource, and the data comprise access control data.

Aspect 60. An electronic device operable to perform the method of aspect 58.

Aspect 61. The electronic device of aspect 60 wherein the electronic device is an electronic lock for controlling access to a resource, and the data comprise access control data.

Aspect 62. A method for controlling access to a resource, the method comprising:

storing, by an electronic device controlling access to the resource, access control data for one or more users, wherein for at least one user, the access control data specify one or more of following parameters for providing access when access is allowed:
activation distance to the user at which the access is to be provided;
a minimum linger time between detecting the user and providing the access;
a requirement to enter a code before providing access;
if the access is through a door comprising an automatic door opener, then whether or not the automatic door opener is to be activated to provide access;

wherein the method further comprises:

detecting a user by the electronic device;

controlling the access in accordance with one or more of the parameters specified by the access control data if the access control data specify one or more of the parameters.

Aspect 63. An electronic device operable to perform the method of aspect 62.

Aspect 64. A method for configuring one or more electronic devices controlling access to one or more resources, the method comprising:

obtaining, by a computer system, access control data for one or more users, wherein for at least one user, the access control data specify one or more of following parameters for providing access when access is allowed:
activation distance to the user at which the access is to be provided;
a minimum linger time between detecting the user and providing the access;
a requirement to enter a code before providing access;
if the access is through a door comprising an automatic door opener, then whether or not the automatic door opener is to be activated to provide access;

wherein the method further comprises causing the one or more electronic devices to store access control data with the one or more of the parameters.

Aspect 65. A computer system configured to perform the method of aspect 64.

Aspect 66. A computer readable memory comprising software operable to cause a computer system to perform the method of aspect 64.

The invention is not limited to the embodiments described above. Other embodiments and variations are within the scope of the invention, as defined by the appended claims.

1. (canceled)

13. A method performed by an electronic device that provides, to one or more users, secure access to a resource, the method comprising:
storing, in the electronic device, access control data which define, for each user, when the user is to have access;
keeping track of a current time;
detecting the user;
determining, from the access control data, whether access is to be provided to the detected user at the current time; and
causing the access to be provided or not provided based on the determining operation;
wherein the device comprises a first memory and a second memory faster than the first memory;
wherein storing access control data comprises:
storing first access control data in the first memory, wherein the first access control data define, for each user, when the user is to have access;
storing second access control data in the second memory, wherein the second access control data is relevant to the current time to define, for each of one or more of the users, whether the user is to have access in one or more time periods comprising the current time;
wherein upon detecting the user whose time-related information is in the second memory, the determining operation uses the second access control data in the second memory.

14. The method of claim 13 further comprising, as the current time advances towards an end of the one or more time periods, refreshing the second access control data in the second memory from the first access control data to cause the second access control data to define, for each of one or more of the users, whether the user is to have access in one or more time periods comprising a future time.

15. An electronic device for performing the method of claim 13.

16. The electronic device of claim 15 wherein the method further comprises, as the current time advances towards an end of the one or more time periods, refreshing the second access control data in the second memory from the first access control data to cause the second access control data to define, for each of one or more of the users, whether the user is to have access in one or more time periods comprising a future time.

17-35. (canceled)

36. The method of claim 14 wherein said refreshing of the second access control data comprises refreshing part of the second access control data while using another part of the second access control data for the determining operation.

37. The method of claim 13 wherein the second access control data comprises a bit for each user, where the bit corresponds to a time period and the bit's value represents whether or not the user has access during the corresponding time period.

38. The method of claim 38 wherein the determining operation comprises determining the value of the bit corresponding to the detected user and the current time; and
the causing operation uses the value of the bit corresponding to the detected user and the current time to cause the access to be provided or not provided.

39. The electronic device of claim 16 wherein in said method, said refreshing of the second access control data comprises refreshing part of the second access control data while using another part of the second access control data for the determining operation.

40. The electronic device of claim 15 wherein in said method, the second access control data comprises a bit for each user, where the bit corresponds to a time period and the bit's value represents whether or not the user has access during the corresponding time period.

41. The electronic device of claim 40 wherein in said method, the determining operation comprises determining the value of the bit corresponding to the detected user and the current time; and
the causing operation uses the value of the bit corresponding to the detected user and the current time to cause the access to be provided or not provided.

42. The electronic device of claim 15 wherein the first memory is a non-volatile memory, and the second memory is a volatile memory.

43. The electronic device of claim 15 wherein the first memory is a serial memory, and the second memory is a random access memory.

44. A method performed by an electronic device that provides, to one or more users, secure access to a resource, the method comprising:
storing, in the electronic device, access control data which define, for each user, when the user is to have access;
keeping track of a current time;
detecting the user;
determining, from the access control data, whether access is to be provided to the detected user at the current time; and
causing the access to be provided or not provided based on the determining operation;
wherein storing access control data comprises:
storing first access control data in the electronic device, wherein the first access control data define, for each user, when the user is to have access;
obtaining second access control data from the first access control data, and storing the second access control data in the electronic device prior to the current time, wherein the second access control data is relevant to the current time to define, for each of one or more of the users, whether the user is to have access in one or more time periods comprising the current time, wherein the second access control data allow faster determination of whether access is to be provided to the detected user at the current time than the first access control data;
wherein upon detecting the user whose time-related information is in the second access control data, the determining operation uses the second access control data.

45. The method of claim 44 wherein in said storing of the access control data, the first access control data are stored in a memory of a first type, and the second access control data are stored in a memory of a second type different from the first type.

46. The method of claim 44 wherein in said storing of the access control data, the first access control data are stored in a non-volatile memory, and the second access control data are stored in a volatile memory.

47. The method of claim 44 wherein in said storing of the access control data, the first access control data are stored a serial memory, and the second access control data are stored in a random access memory.

48. The method of claim 44 further comprising, as the current time advances towards an end of the one or more time periods, refreshing the second access control data from the first access control data to cause the second access control data to define, for each of one or more of the users, whether the user is to have access in one or more time periods comprising a future time.

49. The method of claim 48 wherein said refreshing of the second access control data comprises refreshing part of the second access control data while using another part of the second access control data for the determining operation.

50. The method of claim 44 wherein the second access control data comprises a first bit for each user, where the first bit corresponds to a time period and the first bit's value represents whether or not the user has access during the corresponding time period.

51. The method of claim 50 wherein:
the one or more users are a plurality of users each of which is a member of one or more access groups;
wherein the first access control data define, for each access group, access time during which access is to be provided to the access group;
wherein obtaining the second access control data comprises, for at least one time period:
obtaining, for each access group, a second bit whose value represents whether or not the access group has access during the time period;
for each user, determining the value of the first bit from the second bit of each access group containing the user.
